(19) United States
(12) Patent Application Publication
(10) Pub. No.: US 2006/0120348 A1
(43) Pub. Date: Jun. 8, 2006

(54) Method and apparatus for enabling the downloading of network based information to IP phones

(76) Inventors: Marian Croak, (US); Hossein Eslambolchi, Los Altos Hills, CA (US)

Correspondence Address: Mr. S.H. Dworetsky;AT&T Corp., Room 2A-207, One AT&T Way, Bedminster, NJ, 07921, US

(21) Appl. No.: 11/004,205

(22) Filed: Dec. 3, 2004

(51) Int. Cl. H04L 12/66

(52) U.S. Cl. 370/352

(57) ABSTRACT

The invention provides a method and apparatus for downloading of network based information, such as names, phone numbers, movie timetables or driving directions to IP phones. In one embodiment, the IP phones support Session Initiation Protocol (SIP) and a VoIP service provider provides the directory service. Once the information is received by the IP phone, it becomes a clickable entry in the user's phone log that can be used and browsed by the user just as any other entries in the user's phone logs.

The present invention relates generally to communication networks and, more particularly, to a method and apparatus for enabling the downloading of network based information to Internet Protocol (e.g., VOIP) phones.

### BACKGROUND OF THE INVENTION

Users of IP phones, both wireless and wired ones, frequently place calls by clicking the “SEND” button on entries in electronic phonebooks and logs stored within the phone itself. These electronic phonebooks and logs include received, missed, and dialed calls. This is especially true for callers who are in hands-free situations. Sometimes, the user dials a directory service to request information and will be given verbal information responses to the user's request. However, verbal information can be hard to remember and use, especially the responses are lengthy or complicated.

Therefore, a need exists for a method and apparatus for enabling the downloading of network based information to Internet Protocol (e.g., VOIP) phones requested by the user.

### SUMMARY OF THE INVENTION

In one embodiment, the present invention enables the downloading of network based information, such as names and phone numbers, movie timetables or driving directions to IP phones. Broadly speaking, downloading of such network based information can be viewed as a directory service. In one embodiment, the IP phones support Session Initiation Protocol (SIP) and a VoIP service provider provides the directory service. Once the information is received by the IP phone, it becomes a clickable entry in the user's phone log that can be used and browsed by the user just as any other entries in the user's phone logs.

### BRIEF DESCRIPTION OF THE DRAWINGS

The teaching of the present invention can be readily understood by considering the following detailed description in conjunction with the accompanying drawings, in which:

FIG. 1 illustrates an exemplary Voice over Internet Protocol (VoIP) network related to the present invention;

FIG. 2 illustrates an example of a network based directory information request by a SIP based IP phone of the present invention;

FIG. 3 illustrates a flowchart of a method for requesting and downloading network based directory information by a caller using a SIP based IP phone;

FIG. 4 illustrates a flowchart of a method for handling network based directory information request from an IP phone by a directory service application server; and

FIG. 5 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

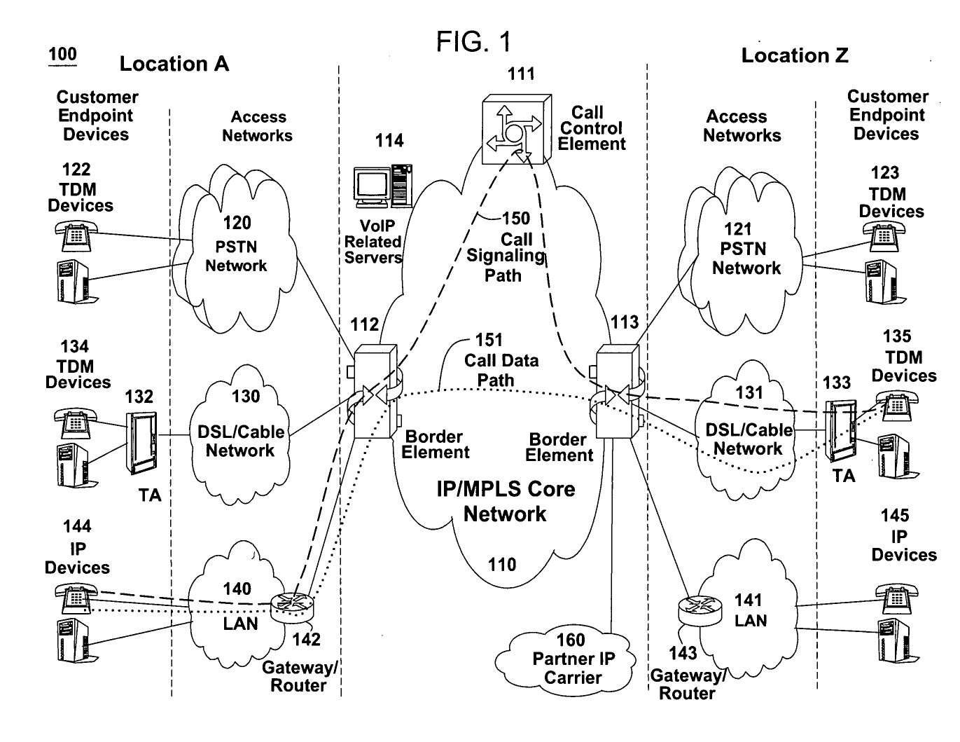

To better understand the present invention, FIG. 1 illustrates an example network, e.g., a VoIP network related to the present invention. The VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. An IP network is broadly defined as a network that uses Internet Protocol to exchange data packets.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, and VoIP related servers 114. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related servers in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related server 114 to obtain the information to complete this call. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, an call acknowledgement signaling message, such as a SIP-ACK message if SIP is used, is sent in the reverse direction back to the CCE 111. After the CCE 111 receives the call acknowledgement message, it will then send a call acknowledgement signaling message, such as a SIP-ACK message if SIP is used, toward the calling party. In addition, the CCE 111 also provides the necessary information of the call to both BE 112 and BE 113 so that the call data exchange can proceed directly between BE 112 and BE 113. The call signaling path 150 and the call data path 151 are illustratively shown in FIG. 1. Note that the call signaling path and the call data path are different because once a call has been setup up between two endpoints, the CCE 111 does not need to be in the data path for actual direct data exchange.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

Users of IP phones, both wireless and wired ones, frequently place calls by clicking the “SEND” button on entries in electronic phonebooks and logs stored within the phone itself. These electronic phonebooks and logs include received, missed, and dialed calls. This is especially true for callers who are in hands-free situations. Sometimes, the user dials a directory service to request information and will be given verbal information responses to the user's request. However, verbal information can be hard to remember and use, especially the responses are lengthy or complicated. To address this criticality, the present invention enables the downloading of network based information, such as name and phone numbers, movie timetables or driving directions, to Session Initiation Protocol (SIP) based Internet Protocol (VOIP) phones from a VoIP service provider providing directory service to a user. Once the information is received by the IP phone, it becomes a clickable entry in the user's phone log that can be used and browsed by the user just as any other entries in the user's phone logs.

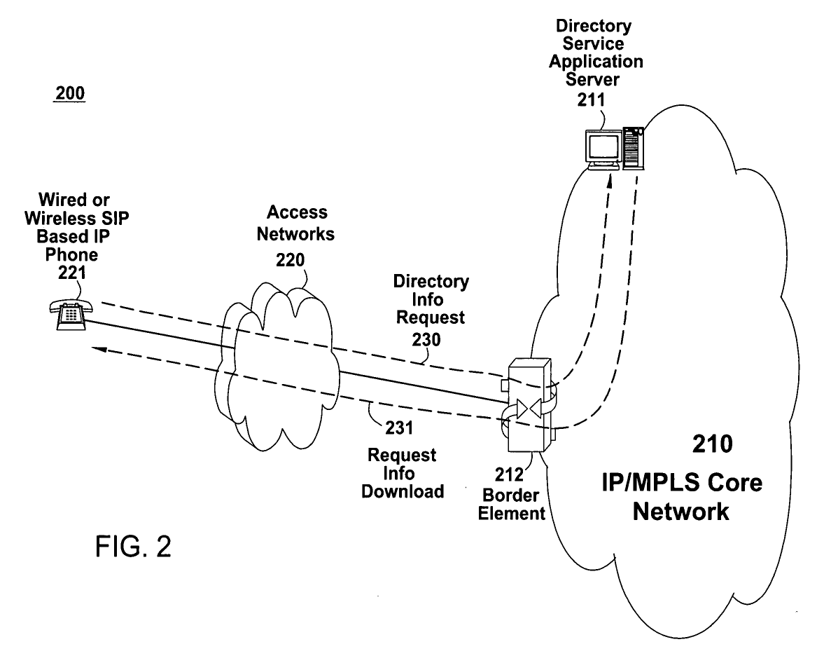

FIG. 2 illustrates an example of a network based directory information request by a SIP based IP phone. A caller uses a SIP based IP phone 221, either a wired or a wireless IP phone, to call the network directory service to request directory information 230. The directory service application server 211 then looks up the requested information and provides the caller the option to download the requested information. The caller chooses the option to download the information. Then, the directory service application server 211 sends the information 231 to the IP phone 221 using SIP messages. Once the IP phone 221 finishes downloading the requested information, the information becomes a clickable entry in the phone log of IP Phone 221. The information can then be retrieved, browsed, or used by the user exactly the same way as any other entries in the phone log.

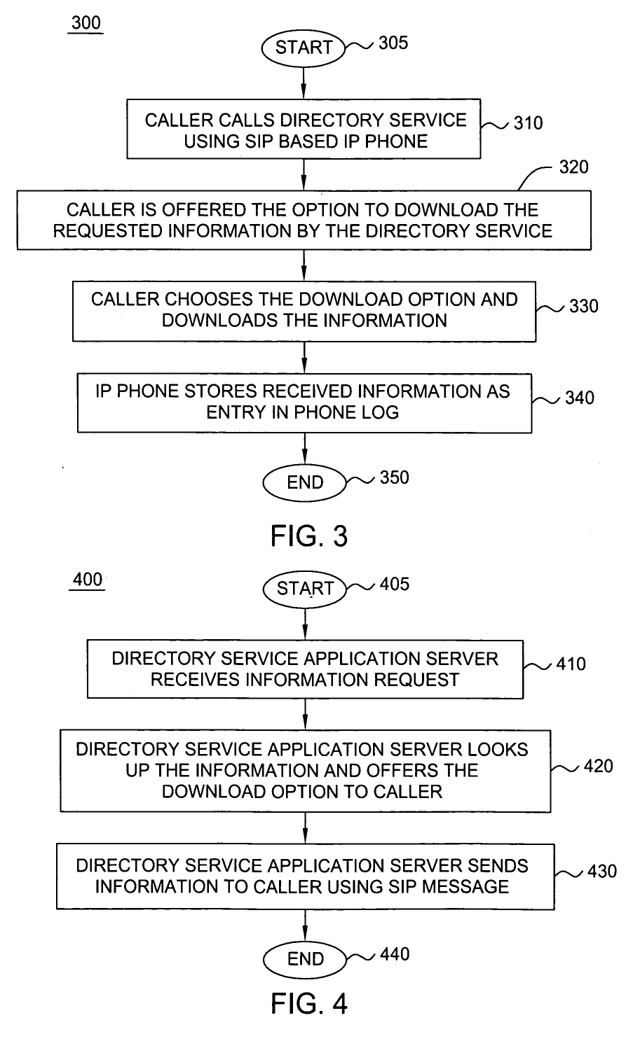

FIG. 3 illustrates a flowchart of a method 300 for requesting and downloading network based directory information by a caller using a SIP based IP phone. Method 300 starts in step 305 and proceeds to step 310.

In step 310, the caller calls the directory service supported by the VoIP service provider, e.g., AT&T, to request for information. The request may comprise network based information, such as names and phone numbers, addresses, names of establishments such as restaurants and theaters, movie timetables, driving directions, and the like.

In step 320, once the requested information has been identified, the caller is offered the option to download the requested information. The option can be audibly presented to the caller, e.g., where the network using artificially generated speech, presents the caller with “Do you wish to download the requested information?” Alternatively, the option and can be presented visually, where a message or an icon can be presented to the screen of the caller's IP phone.

In step 330, the caller accepts the option to download the requested information. For example, the caller can recite “Yes”, or the caller can click on a button on the IP phone to accept the option to download.

In step 340, the downloaded information is stored by the SIP based IP phone as a phone log entry for later use by the caller. The stored information can be selectively viewed by the caller. If the stored information is a phone number, then it can be selected by the caller and the IP phone will automatically dial the stored phone number. If the information is more complicated than a phone number, e.g., driving directions, then clicking on the stored directions will cause the IP phone to audibly recite the driving direction to the caller, e.g., by using a speech synthesizer within the IP phone. The method ends in step 350.

FIG. 4 illustrates a flowchart of a method 400 for handling network based directory information request from an IP phone by a directory service application server, e.g., operated by a service provider. Method 400 starts in step 405 and proceeds to step 410.

In step 410, the directory service application server receives an information request from a caller. The request may comprise network based information, such as names and phone numbers, addresses, names of establishments such as restaurants and theaters, movie timetables, driving directions, and the like.

In step 420, the directory service application server looks up the requested information and offers the option to download the information to the caller. The option to download can be sent to the caller audibly or visually as described above.

In step 430, the directory service application server sends the requested information to the caller using SIP messages after the caller accepts the download option. The method ends in step 440.

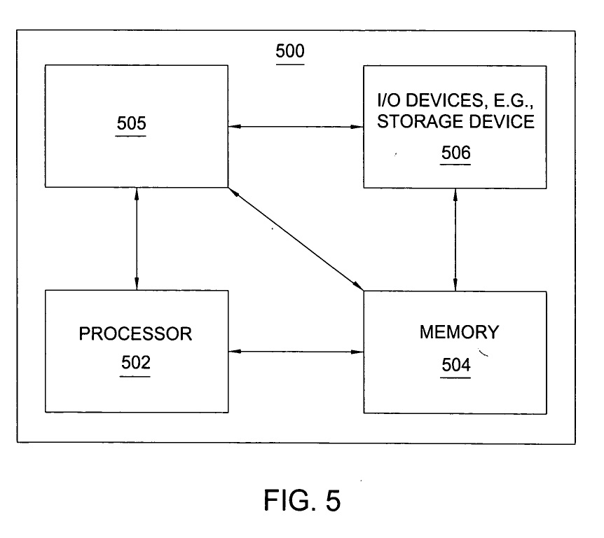

FIG. 5 depicts a high level block diagram of a general purpose computer suitable for use in performing the functions described herein. As depicted in FIG. 5, the system 500 comprises a processor element 502 (e.g., a CPU), a memory 504, e.g., random access memory (RAM) and/or read only memory (ROM), a directory service module 505, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present directory service module or process 505 can be loaded into memory 504 and executed by processor 502 to implement the functions as discussed above. As such, the present single number to multiple devices process 505 (including associated data structures) of the present invention can be stored on a computer readable medium or carrier, e.g., RAM memory, magnetic or optical drive or diskette and the like.

In one embodiment, the number of downloads is tracked by the service provider. Namely, the service provider may charge the caller for each download of requested directory service information.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for downloading directory service information provided by a communications network, comprising:
receiving a request for directory service information from an Internet Protocol (IP) phone; and
downloading the requested directory service information to the Internet Protocol phone.

2. The method of claim 1, wherein said communication network is a Voice over Internet Protocol (VOIP) network.

3. The method of claim 1, wherein said IP phone supports Session Initiated Protocol (SIP).

4. The method of claim 1, wherein said request for directory service information is received by a directory service application server.

5. The method of claim 1, wherein said downloading is performed only after an offer to download said requested directory service information is accepted.

6. The method of claim 1, wherein said downloading comprises:
downloading said requested directory service information to said IP phone using at least one Session Initiated Protocol (SIP) message.

7. The method of claim 1, further comprising:
storing said downloaded directory service information in a phone log of said IP Phone.

8. The method of claim 1, further comprising:
tracking a number of downloads of requested directory service information by said IP phone.

9. The method of claim 8, further comprising:
associating a charge with said number of downloads of requested directory service information by said IP phone.

10. The method of claim 1, wherein said directory service information comprises at least one of a name, a phone number, an address, a name of an establishment, a movie timetable, and a driving direction.

11. An apparatus for downloading directory service information provided by a communications network, comprising:
means for receiving a request for directory service information from an Internet Protocol (IP) phone; and
means for downloading the requested directory service information to the Internet Protocol phone.

12. The apparatus of claim 11, wherein said communication network is a Voice over Internet Protocol (VOIP) network.

13. The apparatus of claim 11, wherein said IP phone supports Session Initiated Protocol (SIP).

14. A computer-readable medium having stored thereon a plurality of instructions, the plurality of instructions including instructions which, when executed by a processor, cause the processor to perform the steps of a method for downloading directory service information provided by a communications network, comprising:
receiving a request for directory service information from an Internet Protocol (IP) phone; and
downloading the requested directory service information to the Internet Protocol phone.

15. The computer-readable medium of claim 14, wherein said communication network is a Voice over Internet Protocol (VoIP) network.

16. The computer-readable medium of claim 15, wherein said IP phone supports Session Initiated Protocol (SIP).

17. The computer-readable medium of claim 14, wherein said downloading is performed only after an offer to download said requested directory service information is accepted.

18. The computer-readable medium of claim 14, wherein said downloading comprises:
downloading said requested directory service information to said IP phone using at least one Session Initiated Protocol (SIP) message.

19. The computer-readable medium of claim 14, further comprising:
tracking a number of downloads of requested directory service information by said IP phone; and
associating a charge with said number of downloads of requested directory service information by said IP phone.

20. A method for receiving directory service information provided by a communications network, comprising:
sending a request for directory service information from an Internet Protocol (IP) phone; and
receiving said requested directory service information into a phone log of said IP Phone.
